(19) United States
(12) Patent Application Publication
(10) Pub. No.: US 2016/0150598 A1
(43) Pub. Date: May 26, 2016

(54) Heating device

(71) Applicant: BEHR-HELLA THERMOCONTROL GMBH, Lippstadt (DE)

(72) Inventors: Lars HEEPER, Paderborn (DE); Karsten MARQUAS, Amsberg (Vosswinkel) (DE); Dirk NAGEL, Paderborn (DE); Matthias STALLEIN, Rietberg (DE); Michael STEINKAMP, Lippstadt (DE)

(73) Assignee: BEHR-HELLA THERMOCONTROL GMBH, Lippstadt (DE)

(21) Appl. No.: 14/899,209

(22) PCT Filed: Jun. 18, 2014
(86) PCT No.: PCT/EP2014/062854

§ 371 Date: Dec. 17, 2015

(30) Foreign Application Priority Data
Jun. 19, 2013 (DE) 10 2013 211 563.6

(51) Int. Cl. H05B 6/10; F24H 1/10

(52) U.S. Cl. CPC H05B 6/108; F24H 1/106; F24H 2250/08

(57) ABSTRACT

The invention relates to a heating device, comprising a housing, which has a fluid channel arranged therein, which has a fluid inlet and a fluid outlet, wherein an element that generates an alternating magnetic field is provided in the housing, which element is separated from the fluid channel in a sealed manner by at least one wall, wherein furthermore at least one metal planar heating element is provided, which can be heated by the alternating magnetic field, wherein the at least one planar heating element is arranged in the fluid channel, wherein at least one of the planar heating elements is made of a magnetic material.

### TECHNICAL FIELD

The invention relates to a heating device having a housing, with, arranged therein, a fluid passage having a fluid inlet and a fluid outlet, wherein an element generating an alternating magnetic field is provided in the housing, which element is separated in a sealed manner from the fluid passage by at least one wall, wherein furthermore there is provided at least one metallic areal heating element which can be heated by means of the alternating magnetic field, wherein the at least one areal heating element is arranged in the fluid passage.

### PRIOR ART

Heating devices are known in the prior art. Thus, there are air-side heating devices which have what are termed PTC heating elements that are supplied with electric current and thereby heat up. The heat is transferred to the air flowing through via air-side fins that are in contact with the PTC elements. However, the construction of these heating devices is fundamentally different to that required for liquid media.

Heating devices for liquid media are provided with a closed housing formed with a fluid passage having a fluid inlet and a fluid outlet, wherein a heating element, which is heated with a PTO element, projects into the housing.

These heating devices for liquid media have the disadvantage that the heat is generated in a different region than in the fluid passage through which flows the liquid medium which is to be heated. This means that delayed heating is achieved due to the transfer resistances present, which must be considered disadvantageous.

### PRESENTATION OF THE INVENTION, OBJECT, SOLUTION, ADVANTAGES

The present invention therefore has the object of providing a heating device which is suitable for heating a fluid inductively, wherein the heating device is characterized in particular by a design which is cost-effective and of low complexity.

The object of the present invention is achieved with a heating device having the features of claim 1.

One exemplary embodiment of the invention relates to a heating device having a housing with, arranged therein, a fluid passage having a fluid inlet and a fluid outlet, wherein an element generating an alternating magnetic field is provided in the housing, which element is separated in a sealed manner from the fluid passage by at least one wall, wherein furthermore there is provided at least one metallic areal heating element which can be heated by means of the alternating magnetic field, wherein the at least one areal heating element is arranged in the fluid passage, wherein at least one of the areal heating elements is made of a magnetic material.

Thus, the element generating the alternating magnetic field is arranged outside the fluid passage and outside the fluid flow through the fluid passage, the areal heating element being arranged in the fluid passage and thus in the fluid flow. This achieves, in a preferred manner, a separation of the electric system, namely between the element generating the alternating magnetic field outside the fluid passage and the areal heating element which heats up inside the fluid passage.

By providing at least one magnetic areal heating element, it is possible to achieve a shielding of the alternating magnetic field. This is advantageous in order to avoid undesired influence on adjacent electric or electronic devices. The magnetic areal heating element makes it possible for the propagation of the alternating magnetic field to be weakened or prevented entirely.

It is also to be preferred if the element generating the alternating magnetic field is enclosed, toward the housing, essentially by a first element made of a magnetic material.

An element made of a magnetic material can be used to reduce or entirely suppress the propagation of the alternating magnetic field. This is particularly advantageous since, by the propagation, undesired negative influence on adjacent electric and/or electronic systems can be avoided. In addition, by limiting the propagation, undesired heating of adjacent metallic structures can be avoided.

Enclosed is advantageously to be understood as meaning that the element generating the alternating magnetic field is enclosed, in particular in the direction of propagation of the alternating magnetic field, by an element made of a magnetic material such that the propagation of the alternating magnetic field is reduced or prevented entirely. In that context, the magnetic material forms a shield for the alternating magnetic field. In the case of an essentially hollow-cylindrical coil as the element generating the alternating magnetic field, the coil could according to the invention for example be enclosed by a hollow-cylindrical element, in that the coil is inserted into this hollow-cylindrical element.

In that context, it is not necessary that the element generating the alternating magnetic field be in physical contact with the element made of a magnetic material or be fully surrounded in the manner of a coating. Advantageously, the element made of a magnetic material is in this case essentially designed according to the shape of the element generating the alternating magnetic field.

It is moreover to be preferred if the housing is made of an electrically nonconductive material.

An electrically nonconductive material such as plastic is particularly advantageous since the total weight of the heating device can thereby be reduced. In addition, the shaping and production of the housing is thereby simpler and more cost-effective.

It is also expedient if the element generating the alternating magnetic field is enclosed, toward the center of the housing, essentially by a second element made of a magnetic material.

Similarly to limiting the propagation of the alternating magnetic field outward toward the housing, it is also possible for the propagation of the alternating magnetic field inward toward the center of the housing to be limited by an element made of a magnetic material. In that context, it is advantageously possible for there to be created, within the housing, a region which is free from influences of the alternating magnetic field.

Furthermore, it is advantageous if one or more areal heating elements, which can be heated up by means of the alternating magnetic field, are arranged between the first element made of a magnetic material and the second element made of a magnetic material.

The areal heating elements can thus be heated up by the alternating magnetic field while the propagation of the alternating magnetic field is limited outward and toward the center of the housing.

It is further to be preferred if the first element made of a magnetic material and/or the second element made of a magnetic material each form an areal heating element.

The elements made of a magnetic material can also constitute areal heating elements, whereby overall a more compact construction of the heating device can be achieved.

It is also advantageous if at least one of the areal heating elements has one or more openings through which a fluid can be made to flow.

Openings, around which or through which a fluid can be made to flow, make it possible to achieve an optimized fluid flow overall. Mixing of the fluid can also be improved, which contributes to greater temperature homogeneity. This improves the efficiency of the heating device overall.

In addition, it is expedient if, through the one or more openings in the respective areal heating element, maximum material quantity of 0% to 50%, preferably of 10% to 40%, in this case preferably of 20% to 30% of the quantity of starting material of the respective areal heating element is rempved.

By providing a minimum. remaining quantity of material for the areal heating element, it can be ensured that the shielding effect remains sufficiently strong in order to sufficiently limit the alternating magnetic field. This holds in particular for areal heating elements which are made of a magnetic material and are arranged in the region of the center of the housing or on one of the internal surfaces of the housing and, inter alia, fulfil the purpose of limiting the propagation of the alternating magnetic field.

According to a particularly advantageous refinement of the invention, it can be provided that the element generating the alternating magnetic field consists of a coil which can be connected to an alternating current source.

Moreover, it is to be preferred if the quantity of heat which results in the element generating the alternating magnetic field, and/or the quantity of heat which results in a control unit controlling and/or adjusting the element generating the alternating magnetic field, can be used to heat the fluid.

This can for example be achieved by means of thermal bridges which establish a thermally conductive connection between the heat-generating regions and the fluid.

It is also advantageous if a fluid can be made to flow against one or both sides of the areal heating element.

The areal heating element is preferably in direct contact with the fluid flowing through the fluid passage. Rapid heating of the fluid is thereby achieved.

Furthermore, it can be particularly advantageous if a fluid is made to flow against both sides of the areal heating element, with the flow direction of the fluid on one side of the areal heating element being the same as or opposite to the flow direction on the other side of the areal heating element. Thus, the fluid is guided in sequence first past one side and then past the other side of the areal heating element. This increases the effectiveness of the heating.

A preferred exemplary embodiment is characterized in that the element generating an alternating magnetic field is an essentially hollow-cylindrical element.

It is also to be preferred if the areal heating element is an essentially hollow cylindrical element.

It is further to be preferred if the element generating an alternating magnetic field is a hollow-cylindrical element, at least one areal heating element being arranged radially inside and/or outside the hollow-cylindrical element generating the alternating magnetic field. A compact heating device can thus be created

It is also to be preferred if one or more hollow-cylindrical areal heating elements are arranged radially inside and outside the hollow-cylindrical element generating the alternating magnetic field. The thermal output can thereby also be increased.

Furthermore, it can be provided that the element generating an alternating magnetic field is an essentially hollow-cylindrical coil.

It is also advantageous if the control unit is connected to the housing or is integrated into the latter.

Furthermore, it can he advantageous if the housing is made of a material which absorbs magnetic fields or is opaque to alternating magnetic fields.

Moreover, it is expedient if the wall is made of a material which is transparent to magnetic fields.

Advantageous refinements of the present invention are described in the subclaims and in the following description of the figures.

### BRIEF DESCRIPTION OF THE DRAWINGS

The invention will he explained in detail below on the basis of exemplary embodiments and with reference to the drawings, in which:

FIG. 1 is a view of a heating device according to the invention, wherein the outer housing is represented only partially and/or transparently,

FIG. 2 is a further view of the heating device as shown in FIG. 1, wherein the central pipe in the heating device is represented in partial section, showing the flow passage and the mandrel inside the pipe, and

FIG. 3 is a further view of the heating device as shown in FIGS. 1 and 2, showing a coil which generates an alternating magnetic field, means of which heating elements inside the heating device can be heated up.

### PREFERRED EMBODIMENT OF THE INVENTION

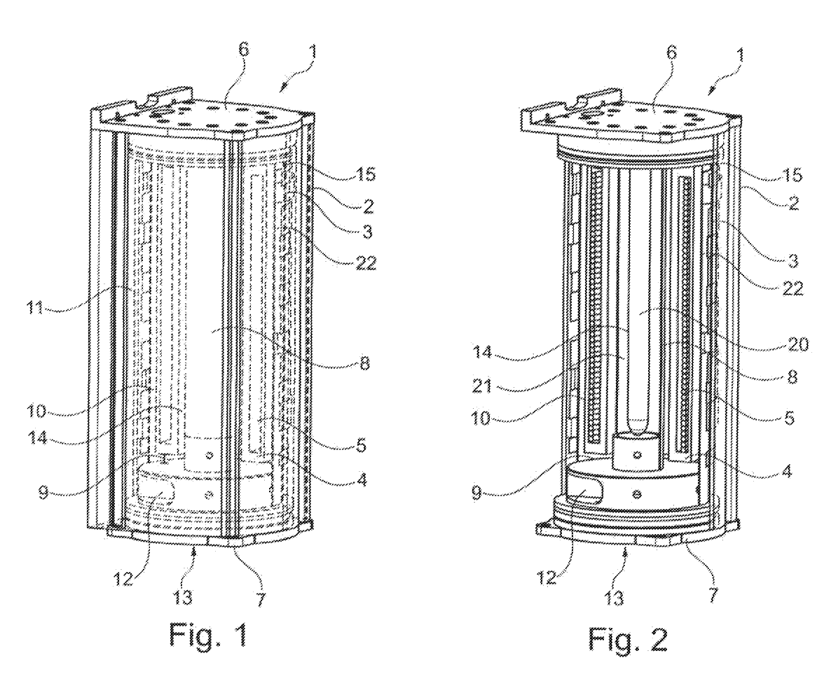

FIG. 1 shows a view of a heating device 1. The heating device 1 is formed by a housing 2 which is closed at the top by a cover 6 and at the bottom by a cover 7. In that context, the housing 2 has a hollow-cylindrical shape. An areal heating element 3 is arranged inside the housing 2 and is also designed as a hollow-cylindrical body. The areal heating element 3 is inserted into the hollow cylinder formed by the housing 2.

The areal heating element has, radially circumferentially, a plurality of slits which divides the outer surface of the areal heating element 3 into a plurality of sections. The individual sections formed by the slits are deflected in various directions from the base surface of the areal heating element 3. The sections are deflected in part radially inward toward center of the areal heating element 3 and in part radially outward toward the housing 2.

A further areal heating element 22 is arranged inside the areal heating element 3. This areal heating element 22 is also in the form of a hollow-cylindrical body. In contrast to the outer areal heating element 3, the areal heating element is not profiled and has a smooth cylindrical lateral surface.

The areal heating element 3 can bear, with individual ones of its deflected sections, both against an internal wall of the housing 2 and against an outward-oriented surface of the areal heating element 22.

A coil housing 4 is arranged inside the areal heating. element 2 and is also of hollow-cylindrical form. The external diameter of the coil housing 4 is smaller than the internal diameter of the areal heating element 22. The external diameter of the areal heating element 22 is smaller than the internal diameter of the areal heating element 3 and the external diameter of the areal heating element 3 is smaller than the internal diameter of the housing 2.

Depending on the configuration, the sections deflected from the base surface of the areal heating element 3 can bear on one hand against the internal surface of the housing 2 and on the other hand against the external surface of the areal heating element 22.

Inside the coil housing 4, which is shown in FIG. 1 in a sectional representation, there is provided a cavity 5 which is of radially circumferential configuration. A coil body can be inserted into this cavity 5 The coil body is not shown in FIG. 1.

A pipe 8 is arranged in the center of the coil housing 4. This pipe 8 is also hollow-cylindrical. The external diameter of the pipe 8 is smaller than the internal diameter of the hollow-cylindrical coil housing 4. The pipe 8 is supported at its lower end region by the lower cover 7. At the upper end region of the pipe 8, there is an air gap between the upper cover 6 and the pipe 8. An air gap 9 is provided between the coil housing 4 and the lower cover 7. By contrast, the upper end region of the coil housing 4 bears areally against the upper cover 6. The pipe 8 also constitutes an areal heating element, provided that it can be inductively heated.

A passage 11, into which the areal heating element 3 is inserted, forms between the housing 2 and the areal heating element 22. A passage 10 forms between the areal heating element 22 and the coil housing 4. Finally, a passage 14 forms between the coil housing 4 and the pipe 8. A fluid can be made to flow through these passages 10, 11, 14. The exact throughflow sequence is represented in the subsequent figures.

The upper cover 6 is configured such that it effects a fluid-tight closure of the top of the housing 2. To that end, the cover 6 projects, with a cylindrical section having a radially circumferential groove, into the interior of the housing 2. As already described, the coil housing 4 bears against a surface of the cover 6 inside the housing 2, such that no fluid flow can flow between the coil housing 4 and the cover 6.

An air gap 15 is provided between the areal heating element 22 and the cover 6, such that it is possible for a fluid flow to result between the passage 10 and the passage 11 over the areal heating element 22.

The lower cover 7 effects a fluid-tight closure of the bottom of the housing 2. To that end, the cover 7 has a cylindrical section having on its radial rim surface a radially circumferential groove, wherein the cover 7 with this cylindrical section is inserted into the housing 2. The cylindrical shape of the cover 7 and/or of the cover 6 in this case corresponds to the internal contour of the housing 2, such that it is possible to create an exact fit between the cover 6, 7 and the housing 2.

The lower cover 7 has, subsequent to the first cylindrical region, a second cylindrical region having a smaller external diameter than the lower first cylindrical region. The pipe 8 sits on this upper cylindrical region of smaller diameter.

The air gap 9 is provided between the coil housing 4 and the cover 7. This air gap 9 allows a fluid flow to flow between the coil housing 4 and the cover 7. The areal heating element 22 is pushed over the upper cylindrical region of the lower cover 7 and sits on the lower cylindrical region. Attachment elements such as screw connections, adhesive bonds or rivet connections can be provided between the upper cylindrical region and the area heating element 22. It is thus possible for the areal heating element 22 to be fixed to the lower cover 7. Equally, the pipe 8 can be fixed to the lower cover 7 by means of similar attachments.

The lower cover 7 has a first fluid connection 12 which is arranged on a radial surface of the upper cylindrical section of the cover 7. Moreover, the cover 7 has a second fluid connection 13 which is arranged on the lower surface of the cover 7 The fluid connection 12 and/or the fluid connection 13 can each serve, depending on the flow direction of the heating device 1, both as a fluid inlet and as a fluid outlet. Inside the cover 7 there is provided a diversion which diverts the radial fluid connection 12 into an axial direction.

FIG. 2 shows a similar representation of the heating device 1, as has already been shown in FIG. 1 In contrast to the representation of FIG. 1, the pipe 8 inside the heating device 1 is represented in section along the central axis of the pipe 8. The figure shows a mandrel 20 running inside the pipe 8. Between the mandrel 20, which is essentially in the form of a rod with a tapered, downward-pointing end, and the internal wall of the pipe 8, there is formed a further passage 21. A fluid can also flow through this passage 21.

In one possible throughflow sequence, a fluid could flow via the fluid connection 13 into the passage 21 inside the pipe 8, where it flows around the mandrel 20. The fluid flows upward through the passage 21 to the cover 6. An air gap is provided between the pipe 8 and the cover 6, allowing the fluid to leave the pipe 8 and flow into the passage 14 formed between the pipe 8 and the coil housing 4. There, the fluid can flow downward and finally flow, is the air gap 9 which is formed between the coil housing 4 and the cover 7, into the passage 10 which is formed between the areal heating element 22 and the coil housing 4 In the upper region, there is provided between the areal heating element 22 and the cover 6 an air gap 15 through which the fluid can flow into the passage 11 that is formed between the areal heating element 22 and the housing internal wall. The fluid can flow downward along the passage 11 and finally flow out of the heating device 1 via the fluid connection 12 in the cover 7. In that context, the areal heating element 3 divides the passage 11 into further part passages through which the fluid can also be made to flow.

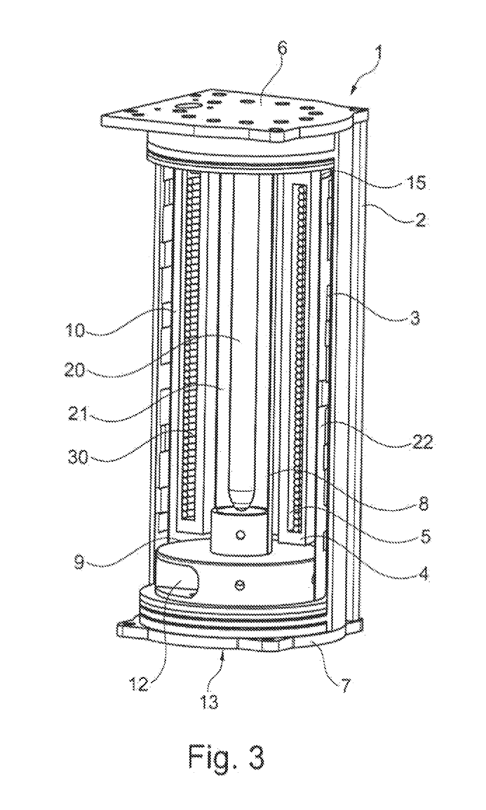

FIG. 3 shows another schematic view of the heating device 1. In contrast to FIGS. 1 and 2, FIG. 3 shows a coil body 30 inside the coil housing 4. The coil body 30 consists of a hollow-cylindrical, singly-wound coil. A multiply-wound, in particular a doubly-wound coil can alternatively also be provided.

By supplying the coil body 30 with current, for example with an AC voltage, a magnetic field can be generated inside the heating device 1. In that context, both the pipe 8 and the areal heating elements 3 and 22 are made of a metallic material.

The pipe 8 and the areal heating elements 3 and 22 can be heated by the alternating magnetic field which is generated by the coil body 30. A flu:id can flow past the areal heating elements 3 and 22 and also the pipe 8, which fluid takes up the heat from the areal heating elements 3 and 22 and/or from the pipe 8 as it flows past.

The areal heating element 3 and the pipe 8 are advantageously made of a magnetic material. It is thus possible to confine the spatial extent of the alternating magnetic field generated by the coil body 30. This is in particular advantageous in order to minimize, as much as possible, the effects of the alternating magnetic field outside the housing 2. In addition, a pipe 8 made of a magnetic material can be used to realize an internal region of the heating device I which is free from the alternating field.

Confining the alternating magnetic field is in particular advantageous in order to avoid, as far as possible, undesired interactions with adjacent electric or electronic systems. Moreover, it is advantageous in order to exclude undesired heating of other metallic materials. Furthermore, limiting the alternating magnetic field to a concentrated, predefined space can achieve a higher efficiency of the heating device I overall since the losses due to leakage of the alternating magnetic field are lower.

The housing 2 can, in one advantageous configuration, in particular when the areal heating element 3 is made of a magnetic material, be made of a non-metallic or electrically nonconductive or non-magnetic material such as for example a plastic.

The embodiment of the heating device as represented in FIGS. 1 to 3, is merely by way of example. The representation of FIGS. 1 to 3 and the associated description have no limiting effect. FIGS. 1 to 3 show, in particular, embodiment which, an arrangement of multiple hollow-cylindrical bodies with respect to one another, forms passages through which a fluid can be made to flow. The inventive principle of the heating device 1 can equally be applied to otherwise formed elements of a heating device.

In particular with respect to the choice of materials, the dimensions and the orientation of the individual elements with respect to one another, FIGS. 1 to 3 merely represent an exemplary embodiment and do not have any limiting character. The individual features of the exemplary embodiments can be combined with one another.

1. A heating device having a housing with, arranged therein, a fluid passage having a fluid inlet and a fluid outlet, wherein an element generating an alternating magnetic field is provided in the housing, which element is separated in a sealed manner from the fluid passage by at least one wall, wherein furthermore there is provided at least one metallic areal heating element which can be heated by means of the alternating magnetic field, wherein the at least one areal heating element is arranged in the fluid passage, wherein at least one of the areal heating elements is made of a magnetic material.

2. The heating device as claimed in claim 1 wherein the element generating the alternating magnetic field is enclosed, toward the housing, essentially by a first element made of a magnetic material.

3. The heating device as claimed in claim 2, wherein the housing is made of an electrically nonconductive material.

4. The heating device as claimed in claim 1 wherein the element generating the alternating magnetic field is enclosed, toward the center of the housing, essentially by a second element made of a magnetic material.

5. The heating device as claimed in claim 1, wherein one or more areal heating elements, which can be heated up by means of the alternating magnetic field, are arranged between the first element made of a magnetic material and the second element made of a magnetic material.

6. The heating device as claimed in claim 1, wherein the first element made of a magnetic material and/or the second element made of a magnetic material each form an areal heating element.

7. The heating device as claimed in claim 1, wherein at least one of the areal heating elements has one or more openings through which a fluid can be made to flow.

8. The heating device as claimed in claim 7, wherein, through the one or more openings in the respective areal heating element, a maximum material quantity of 0% to 50%, preferably of 10% to 40%, in this case preferably of 20% to 30% of the quantity of starting material of the respective areal heating element is removed.

9. The heating device as claimed in claim 1, wherein the element generating the alternating magnetic field consists of a coil which can be connected to an alternating current source.

10. The heating device as claimed in claim 1, wherein the quantity of heat which results in the element generating the alternating magnetic field, and/or the quantity of heat which results in a control unit controlling and/or adjusting the element generating the alternating magnetic field, can be used to heat the fluid.
